(19) United States
(12) Patent Application Publication
(10) Pub. No.: US 2015/0081491 A1
(43) Pub. Date: Mar. 19, 2015

(54) INTRADAY CASH FLOW OPTIMIZATION

(71) Applicant: International Business Machines Corporation, Armonk, NY (US)

(72) Inventors: JoAnn P. Brereton, Hawthorne, NY (US); Arun Hampapur, Norwalk, CT (US); Hongfei Li, Briarcliff Manor, NY (US); Robin Lougee, Yorktown Heights, NY (US); Buyue Qian, Ossining, NY (US)

(73) Assignee: International Business Machines Corporation, Armonk, NY (US)

(21) Appl. No.: 14/027,411

(22) Filed: Sep. 16, 2013

(51) Int. Cl. G06Q 40/00

(52) U.S. Cl. CPC G06Q 40/00
USPC 705/35

(57) ABSTRACT

Embodiments relate to intraday cash flow optimization. Transactions are accessed on a business-to-business integration network from a plurality of sources linked with payment delivery system data from a financial service system. The transactions are associated with two or more compartmentalized entities. The transactions are characterizes based on the payment delivery system data and an analysis of customer profile data. The transactions associated with two or more compartmentalized entities are linked as integrated information based on the characterizing of the transactions. An intraday receivables prediction engine and an intraday payables prediction engine are applied to the integrated information to produce an estimation of intraday cash flow. The estimation of intraday cash flow is monitored relative to intraday operations optimization conditions. An alert is generated based on determining that at least one of the intraday operations optimization conditions is met.

### BACKGROUND

The present invention relates to bank management systems and, more specifically, to intraday cash flow optimization systems and methods for banking organizations.

BASEL III is a set of worldwide banking standards to regulate the amount of capital that banks need to keep on hand for intraday transactions. The intent of BASEL III is to increase bank liquidity and to reduce the amount of leverage. BASEL III requires banks to monitor transaction operations in a shorter time window with broader context as compared to earlier standards known as BASEL II. Monitoring current liquidity is particularly challenging for large banking organizations which include relatively isolated departments that operate using substantially independent systems and processes. As banking organizations are merged or acquired and assimilated, there is a greater tendency to operate various departments or divisions separately.

Bank transactions often involve a period of latency that can span multiple days for the transactions to complete. For example, a transfer of funds between accounts can take two or more days to clear. Backend systems typically resolve transactions in batches within a day or two of initiating the transactions. Transaction latency increases uncertainty in estimating current liquidity at any given point in time. Operational costs for banks increase as a larger amount of reserves are maintained to buffer for uncertainty and latency.

### SUMMARY

According to one embodiment of the present invention, a method for intraday cash flow optimization is provided. The method includes accessing, by a processor, transactions on a business-to-business integration network from a plurality of sources linked with payment delivery system data from a financial service system. The transactions are associated with two or more compartmentalized entities. The transactions are characterizes based on the payment delivery system data and an analysis of customer profile data. The transactions associated with two or more compartmentalized entities are linked as integrated information based on the characterizing of the transactions. An intraday receivables prediction engine and an intraday payables prediction engine are applied to the integrated information to produce an estimation of intraday cash flow. The estimation of intraday cash flow is monitored relative to intraday operations optimization conditions. An alert is generated based on determining that at least one of the intraday operations optimization conditions is met.

According to another embodiment of the present invention, a system for intraday cash flow optimization is provided. The system includes a processor communicatively coupled to a business-to-business integration network and a financial service system. An intraday cash flow optimization tool is executable by the processor. The intraday cash flow optimization tool is configured to implement a method. The method includes accessing, by the processor, transactions on the business-to-business integration network from a plurality of sources linked with payment delivery system data from a financial service system. The transactions are associated with two or more compartmentalized entities. The transactions are characterizes based on the payment delivery system data and an analysis of customer profile data. The transactions associated with two or more compartmentalized entities are linked as integrated information based on the characterizing of the transactions. An intraday receivables prediction engine and an intraday payables prediction engine are applied to the integrated information to produce an estimation of intraday cash flow. The estimation of intraday cash flow is monitored relative to intraday operations optimization conditions. An alert is generated based on determining that at least one of the intraday operations optimization conditions is met.

According to a further embodiment of the present invention, a computer program product for intraday cash flow optimization is provided. The computer program product includes a storage medium embodied with machine-readable program instructions, which when executed by a computer causes the computer to implement a method. The method includes accessing transactions on the business-to-business integration network from a plurality of sources linked with payment delivery system data from a financial service system. The transactions are associated with two or more compartmentalized entities. The transactions are characterizes based on the payment delivery system data and an analysis of customer profile data. The transactions associated with two or more compartmentalized entities are linked as integrated information based on the characterizing of the transactions. An intraday receivables prediction engine and an intraday payables prediction engine are applied to the integrated information to produce an estimation of intraday cash flow. The estimation of intraday cash flow is monitored relative to intraday operations optimization conditions. An alert is generated based on determining that at least one of the intraday operations optimization conditions is met.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which intraday cash flow optimization may be implemented according to an embodiment of the present invention;

FIG. 2 depicts a high-level data flow diagram for an intraday cash flow optimization according to an embodiment;

FIG. 3 depicts a low-level data flow diagram for intraday cash flow optimization according to an embodiment;

FIG. 4 depicts a process for intraday cash flow optimization according to an embodiment; and

FIG. 5 depicts a computer system for intraday cash flow optimization according to an embodiment.

### DETAILED DESCRIPTION

Exemplary embodiments provide intraday cash flow optimization for banking or financial organizations. Embodiments leverage a business-to-business integration network to access transactions from multiple sources to assist in determining an estimate of intraday cash flow. The transactions are associated with two or more compartmentalized entities, also referred to as “silos”, which can be effectively isolated from each other and observed without direct modification. The transactions link transaction data from multiple sources to payment delivery system data, where the payment delivery system data can be used to establish a domain business process for a banking or financial organization. The transactions can be characterized based on the payment delivery system data and an analysis of customer profile data. The transactions associated with two or more compartmentalized entities are linked as integrated information based on the characterizing of the transactions.

Historical transaction data can be analyzed offline to search for patterns and develop model parameters. The model parameters can be applied for real-time analytics in conjunction with external data to predict intraday receivables and intraday payables. Reconciling the intraday receivables prediction and the intraday payables prediction at different levels of hierarchy can produce an overall estimation of intraday cash flow as well as an estimation of intraday cash flow on a customer and account basis. Once estimation of intraday cash flow is performed, the estimate can be used for real-time alerts, reinvestment suggestions, and/or other monitoring purposes for intraday cash flow optimization.

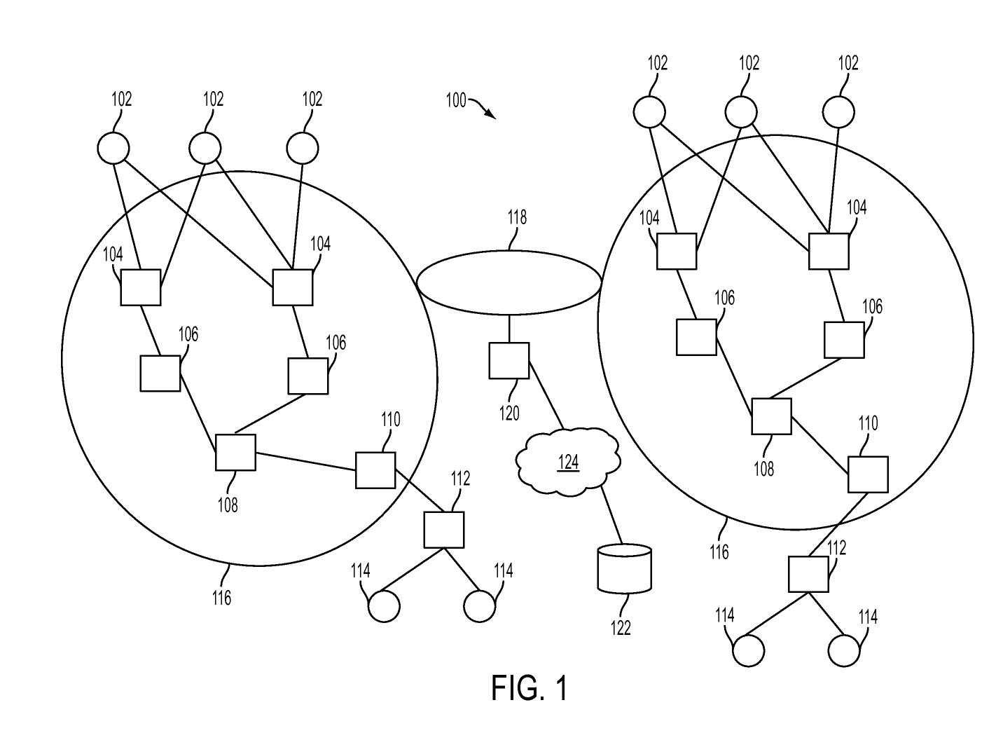

Turning now to FIG. 1, a bank management system 100 upon which intraday cash flow optimization may be implemented will now be described in an exemplary embodiment. The bank management system 100 includes a plurality of electronic access points 102 in communication with gateways 104. Each of the gateways 104 may be coupled to a department computer system 106. Each department computer system 106 is coupled to a regional banking computer system 108. The regional banking computer system 108 may also be accessed via gateway 110 by bank branches 112 that provide physical access to customers 114. The bank management system 100 is partitioned into regional banking networks 116 that are joined by a business-to-business integration network 118. The regional banking networks 116 may be geographically distributed in different locations, such as California, New York, etc.

Other systems may also be coupled to the business-to-business integration network 118. In one example, an intraday cash flow optimization computer system 120 is coupled to the business-to-business integration network 118, where the intraday cash flow optimization computer system 120 is configured to provide estimates of the intraday cash flow and optimizations based on the estimates. The intraday cash flow optimization computer system 120 can also access external data sources 122 in real-time through a network 124. The external data sources 122 may be third-party generated data, such as credit reports, new reports, stock market data, bond market data, and the like. The network 124 may be any type of network known in the art. In one example, the network 124 is the Internet.

Although the bank management system 100 is depicted in FIG. 1 as including two substantially similar regional banking networks 116 joined by the business-to-business integration network 118, the scope of embodiments is not so limited. There may be any number of instances of the electronic access points 102, gateways 104, department computer system 106, regional banking computer system 108, gateway 110, bank branches 112, and regional banking networks 116 with various topologies. Additional elements can be added, removed, or combined in the regional banking networks 116. Moreover, the intraday cash flow optimization computer system 120 can be distributed in multiple computer systems and can access other networks and/or data sources (not depicted). In exemplary embodiments, the business-to-business integration network 118 provides a generic communication interface between a number of elements that may otherwise be isolated from each other. For example, instances of the department computer system 106 can be separate compartmentalized entities or silos, where a trust department may not have direct access to data in a treasury department even within the same regional banking network 116.

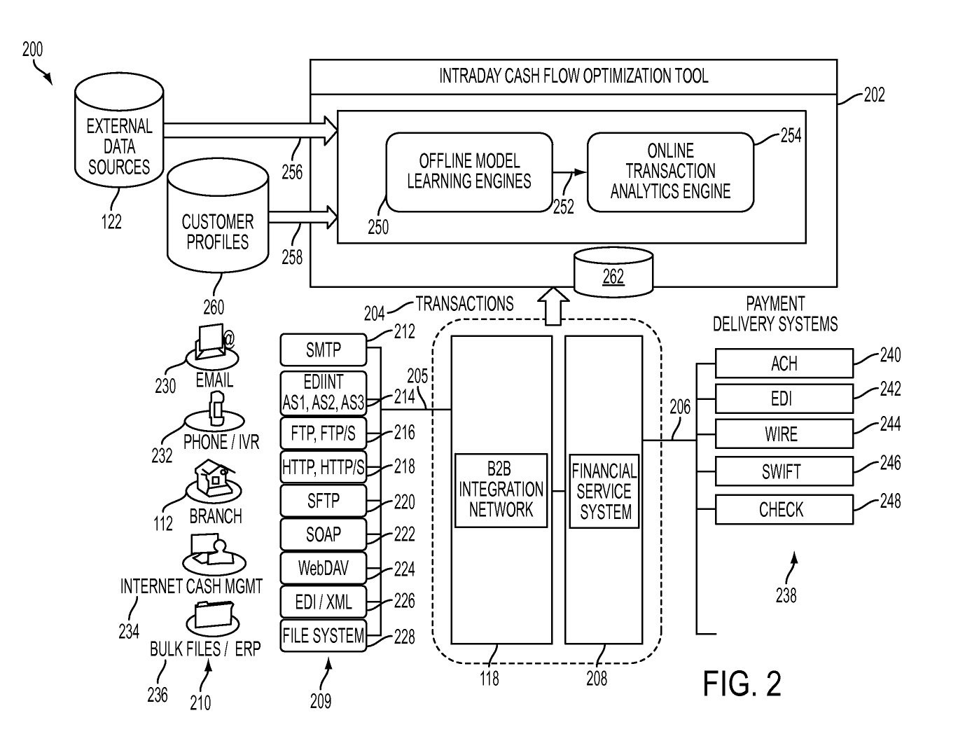

FIG. 2 depicts a high-level data flow diagram 200 for an intraday cash flow optimization according to an embodiment. An intraday cash flow optimization tool 202 may be executed on the intraday cash flow optimization computer system 120 of FIG. 1. The intraday cash flow optimization tool 202 can access transactions 204 on the business-to-business integration network 118 of FIG. 1 from a number of sources 210 linked with payment delivery system data 206 from a financial service system 208. The business-to-business integration network 118 can interface to a number of protocols 209 to receive transaction data 205 from the sources 210. For example, the sources 210 can communicate the transaction data 205 via protocols 209 such as Simple Mail Transfer Protocol (SMTP) 212, Electronic Data Interchange-Internet Integration (EDIINT) 214, File Transfer Protocol (FTP) 216, Hypertext Transfer Protocol (HTTP) 218, Secure File Transfer Protocol (SFTP) 220, Simple Object Access Protocol (SOAP) 222, Web Distributed Authoring and Versioning (WebDAV) 224, Electronic Data Interchange (EDI)/eXtensible Markup Language (XML) 226, and various file systems 228.

The sources 210 of the transaction data 205 can include a variety of inputs from the electronic access points 102 of FIG. 1, bank branches 112 of FIG. 1, or other elements of the regional banking networks 116 of FIG. 1, such as requests from a department computer system 106 of FIG. 1 or regional banking computer system 108 of FIG. 1 as compartmentalized entities. For example, the sources 210 can include e-mail 230, phone/interactive voice response 232, bank branches 112, internet cash management software 234, and bulk files/Enterprise Resource Planning (ERP) 236 to provide the transaction data 205 for the transactions 204. The business-to-business integration network 118 provides a common format for the transaction data 205 to be processed from the sources 210 using any of the protocols 209. The transaction data 205 can be configured in a generalized format that is linked to the payment delivery system data 206 in the transactions 204. In this way, the relative isolation or compartmentalization of each source 210 of the transaction data 205 and payment delivery systems 238 providing the payment delivery system data 206 can be maintained while the transactions 204 are examined by the intraday cash flow optimization tool 202.

The financial service system 208 may be supported by various components of the bank management system 100 of FIG. 1 according to the payment delivery systems 238. For example, a department computer system 106 of FIG. may support a subset of the payment delivery systems 238, while a regional banking computer system 108 of FIG. 1 supports another subset of the payment delivery systems 238. Examples of the payment delivery systems 238 include Automated Clearing House (ACH) 240, Electronic Data Interchange (EDI) 242, wire 244, Society for Worldwide Interbank Financial Telecommunication (SWIFT) 246, and check 248. The financial service system 208 can interface with the different payment delivery systems 238 providing the payment delivery system data 206, where the payment delivery system data 206 provide business process detail and correlate to the transaction data 205 in the transactions 204. For example, a transaction 204 can be made by e-mail 230, sent using SMTP 212, and include payment delivery system data 206 using a payment delivery system 238 of ACH 240. Transaction data 205 may include customer identifiers, account information, routing information, and other constraints associated with the transactions 204. The payment delivery systems 238 can also be treated as separate compartmentalized entities or silos, where each payment delivery system 238 is independently managed relative to each other.

The intraday cash flow optimization tool 202 includes one or more offline model learning engines 250 that can access historical values of the transactions 204 including transaction data 205 and payment delivery system data 206 as historical transaction data 262 for identifying patterns to produce model parameters 252. The model parameters 252 may be formatted as coefficients to be applied by an online transaction analytics engine 254. Pattern analysis can include looking for repeating sequences of the transactions 204 based on a particular customer or account. The patterns may also include tracking time between posting and completion of repeated transactions 204 based on a particular source 210, customer, account, and/or payment delivery system 238. Failed transactions 204, for instance, due to insufficient funds, may also be tracked on a customer and/or account basis to determine a risk factor or likelihood of repetition of a similar pattern. The one or more offline model learning engines 250 may operate on data spanning several years to improve a level of confidence associated with identified patterns used to create the model parameters 252. The one or more offline model learning engines 250 may also access external information 256 from the external data sources 122 in developing patterns for the model parameters 252. For example, accessing a customer credit report can increase confidence in a likelihood of repetition of successful or failed transactions 204.

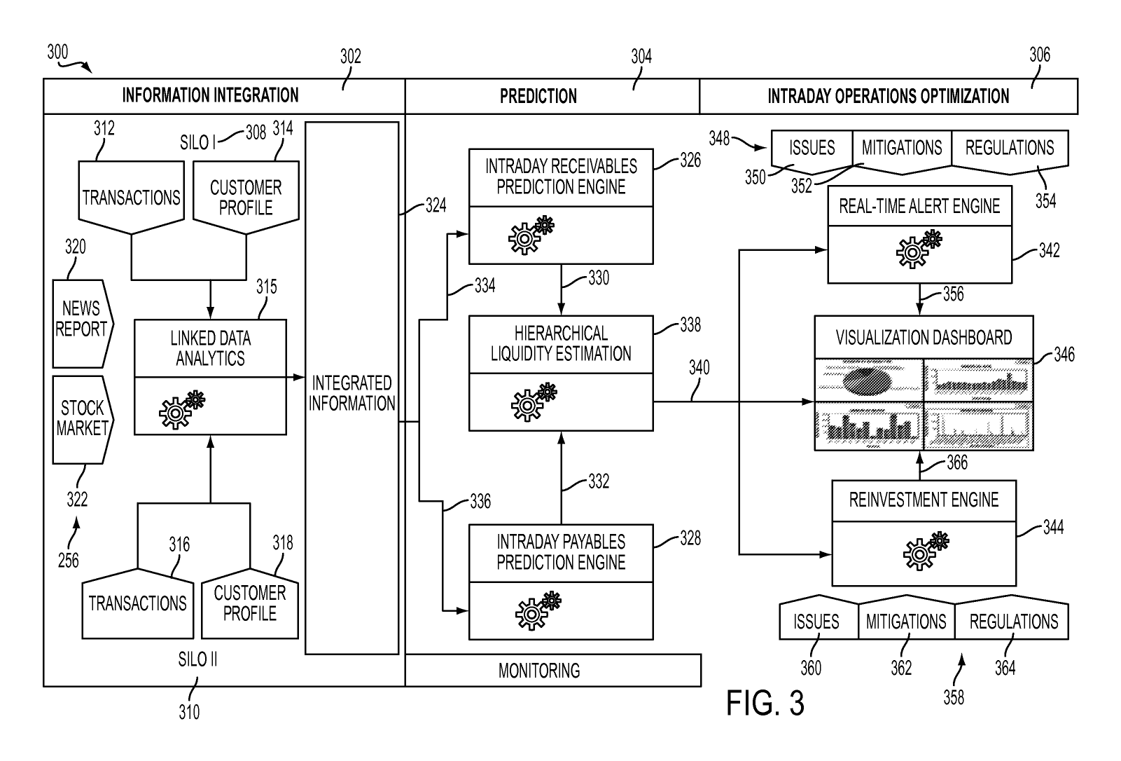

The online transaction analytics engine 254 can apply the model parameters 252 to the transactions 204 in real-time in combination with customer profile data 258 from customer profiles 260 and external information 256 from external data sources 122. For example, accessing Bloomberg reports as the external information 256 for a business account can provide further insight as to the likelihood of the transactions 204 following previous patterns or an increased risk of failing to repeat previous patterns, e.g., based on a recent negative report associated with customer profile data 258 for a particular customer involved in a transaction 204. The online transaction analytics engine 254 may be comprised of a separate intraday receivables prediction engine to produce an intraday receivables prediction and an intraday payables prediction engine to produce an intraday payables prediction as further described in reference to FIG. 3.

FIG. 3 depicts a low-level data flow diagram 300 for intraday cash flow optimization according to an embodiment. The data flow diagram 300 depicts three stages including information integration 302, prediction and monitoring 304, and intraday operations optimization 306. The information integration 302 includes a first silo 308 and a second silo 310 in this example, where the first and second silos 308 and 310 are examples of compartmentalized entities. The first and second silos 308 and 310 may be associated with separate bank departments, organizations, or systems, such as different instances of the department computer system 106 or regional banking computer system 108 of FIG. 1.

The first silo 308 provides transactions 312 and customer profile data 314 to linked data analytics 315. The second silo 310 provides transactions 316 and customer profile data 318 to the linked data analytics 315. The transactions 312 and 316 may be instances of the transactions 204 of FIG. 2, and the customer profile data 314 and 318 may be instances of the customer profile data 258 of FIG. 2. The linked data analytics 315 also receives the external information 256 that may include news reports 320, stock market data 322, as well as other sources (not depicted). The linked data analytics 315 combines data from various sources such as the first silo 308, the second silo 310, and the external information 256 to produce integrated information 324. The transactions 312 and 316 can be characterized based on the payment delivery system data 206 of FIG. 2 and an analysis of the customer profile data 314 and 318. The characterized transactions 312 and 316 may have common dates, account numbers, and customer data that enable grouping and integration of data even though they originated from different compartmentalized entities, such as the first and second silos 308 and 310.

The integrated information 324 is provided to an intraday receivables prediction engine 326 and an intraday payables prediction engine 328. As previously described, the intraday receivables prediction engine 326 and the intraday payables prediction engine 328 may be components of the online transaction analytics engine 254 of FIG. 2. The intraday receivables prediction engine 326 is configured to produce an intraday receivables prediction 330, and the intraday payables prediction engine 328 is configured to produce an intraday payables prediction 332. The intraday receivables prediction engine 326 can extract and operate on receivable data 334 from the integrated information 324, while the intraday payables prediction engine 328 can extract and operate on payable data 336 from the integrated information 324.

An example of a prediction model that be applied by the intraday receivables prediction engine 326 and/or the intraday payables prediction engine 328 is provided in equation 1 as follows.

y_{—}t=a1*y_(t−1)+a2*y_(t−2)+ . . . +ak*y_(t−k)+b1*y_(t−24)+b2*y_(t−30)+c1*x1_{—}t+c2*x2_{—}t+ . . . +cp*xp_{—}t+white noise, (Eq. 1)

where y_t is an hourly transaction amount at hour t, t=1, . . . , 24 and hourly transaction amount at hour t, t=1, . . . , 24. Accordingly, y_(t−24) indicates a transaction at the same hour one day before to capture a daily pattern, and y_(t−168) indicates a transaction at the same hour one week before to capture the weekly pattern. Values x1_t, x2_t, . . . , xp_t are other contributing factors, and a1, a2, . . . , cp are parameters which indicate factor impacts. The parameters a1, a2, . . . , cp may be derived from the model parameters 252 of FIG. 1. Once the model parameters 252 of FIG. 1 are estimated, y_t can be predicted for a transaction amount at future time t. When applied to the receivable data 334 and the payable data 336, the intraday receivables prediction engine 326 and the intraday payables prediction engine 328 can respectively produce the intraday receivables prediction 330 and the intraday payables prediction 332.

A hierarchical liquidity estimation 338 is performed to reconcile the intraday receivables prediction 330 and the intraday payables prediction 332 in a hierarchical format to produce an estimation of intraday cash flow 340. The intraday receivables prediction 330 and the intraday payables prediction 332 may be produced on a customer and account basis. Accordingly, the hierarchical liquidity estimation 338 can perform liquidity analysis on a customer or account basis, as well as at different levels of bank organization, such as a branch level, department level, regional level, and the like. The estimation of intraday cash flow 340 may be provided to a real-time alert engine 342, a reinvestment engine 344, and/or to a visualization dashboard 346.

The real-time alert engine 342 can monitor the estimation of intraday cash flow 340 relative to intraday operations optimization conditions 348. The intraday operations optimization conditions 348 can be defined as near threshold limits to trigger an alert prior to violating one or more of the intraday operations optimization conditions 348. The intraday operations optimization conditions 348 may include one or more of: known issues 350 for account management, mitigation rules 352 of accounts, and regulations 354 for maintaining liquidity. Examples of known issues 350 for account management can be defined as alert limits for constraints on an account, location/time based issues, minimum balance rules, and the like. Examples of mitigation rules 352 of accounts can be defined as alert limits for keeping money in an account for a certain period of time, limits for triggering specific actions, account closure rules, and the like. The regulations 354 for maintaining liquidity can be defined as alert limits for liquidity and higher level rules defined according to, for example, BASEL III regulations. The real-time alert engine 342 can generate an alert 356 based on determining that at least one of the intraday operations optimization conditions 348 is met. The alert 356 may be in the form of an electronic message, audio or video output, and/or data provided to the visualization dashboard 346 for further processing.

The reinvestment engine 344 can monitor the estimation of intraday cash flow 340 relative to reinvestment conditions 358. The reinvestment engine 344 can analyze the estimation of intraday cash flow 340 to determine where excess intraday cash flow exists and provide one or more reinvestment options 366 based on determining that at least one of the reinvestment conditions 358 is met by the estimation of intraday cash flow 340. The one or more reinvestment options 366 may be in the form of an electronic message, audio or video output, and/or data provided to the visualization dashboard 346 for further processing. Similar to the intraday operations optimization conditions 348, the reinvestment conditions 358 may include one or more of: known issues 360 for account management, mitigation rules 362 of accounts, and regulations 364 for maintaining liquidity. Rather than comparing the reinvestment conditions 358 to minimum threshold limits, the reinvestment conditions 358 may define safe maximum values where liquidity above the maximum threshold limits can be reinvested without a likely risk of failing to meet intraday liquidity requirements. The reinvestment engine 344 may access the external information 256 in making recommendations based on current market conditions, where a larger excess liquidity can support consideration of incrementally greater investment risk. For example, a tiered risk strategy in investment options can be applied as a greater amount of liquidity is identified.

The visualization dashboard 346 can summarize the estimation of intraday cash flow 340, any alert 356, and/or reinvestment options 366. The visualization dashboard 346 may be a collection of static data or can be interactive, allowing a user to drilldown into different organization, department, customer, and account level data. There can be multiple instances of the visualization dashboard 346, where different users can access underlying data but apply different views or filters to the data. Interaction with the visualization dashboard 346 can also trigger other actions, such as initiating one of the reinvestment options 366 suggested by the reinvestment engine 344.

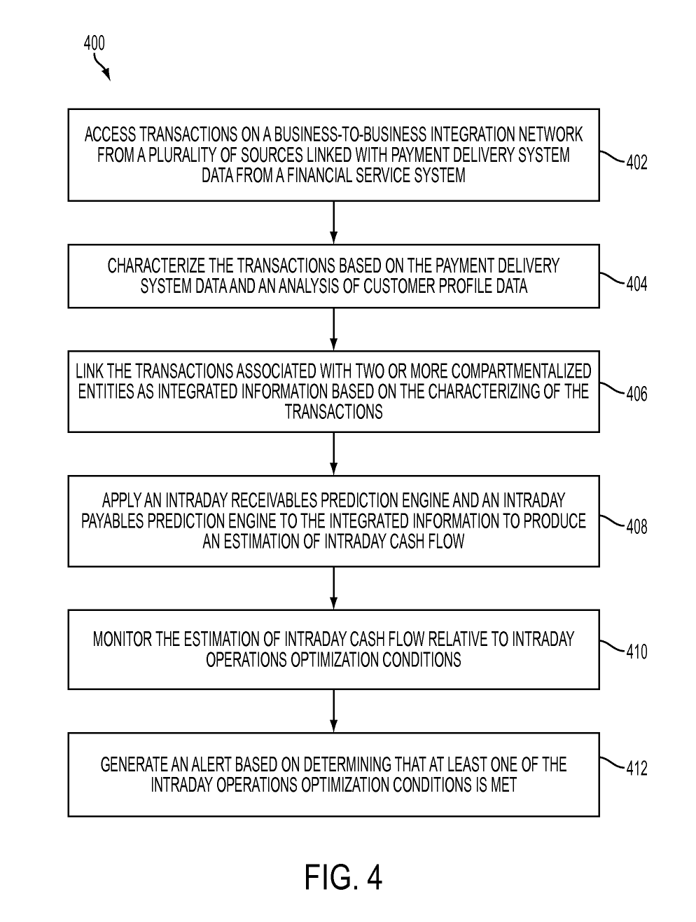

FIG. 4 depicts a process 400 for intraday cash flow optimization in accordance with an embodiment. The process 400 is described in reference to FIGS. 1-4 and need not be performed in the precise order as depicted in FIG. 4. In this example, a processor of the intraday cash flow optimization computer system 120 of FIG. 1 executes the intraday cash flow optimization tool 202 to perform the process 400. At block 402, the intraday cash flow optimization tool 202 accesses transactions 204 on the business-to-business integration network 118 from a plurality of sources 210 linked with payment delivery system data 206 from the financial service system 208. The transactions 204 can be the transactions 312 and 316 associated with two or more compartmentalized entities, such as silos 308 and 310.

At block 404, the intraday cash flow optimization tool 202 characterizes the transactions 204 based on the payment delivery system data 206 and an analysis of customer profile data 258. With respect to the transactions 312 and 316, the customer profile data 258 is comprised of customer profile data 314 and 318. The analysis of the customer profile data 314 and 318 can include determining customer and account information associated with the transactions 312 and 316 on a compartmentalized entity basis, i.e., per silo 308, 310.

At block 406, the intraday cash flow optimization tool 202 links the transactions 312 and 316 associated with the silos 308 and 310 as two or more compartmentalized entities to form integrated information 324 based on the characterizing of the transactions 312 and 316. Linking can be performed by the linked data analytics 315. External information 256 can be accessed in real-time to link with the transactions 312 and 316 and form the integrated information 324. The external information 256 may relate to one or more of: the transactions 312, 316 and the customer profile data 314, 318.

At block 408, the intraday cash flow optimization tool 202 applies the intraday receivables prediction engine 326 and the intraday payables prediction engine 328 to the integrated information 324 to produce an estimation of intraday cash flow 340. One or more offline model learning engines 250 can be applied to produce model parameters 252 based on identifying patterns in historical transaction data 262. The model parameters 252 are applied to the transactions 312, 316 in real-time in combination with the customer profile data 314, 318 and external information 256 from external data sources 122 by the online transaction analytics engine 254. The online transaction analytics engine 254 can include the intraday receivables prediction engine 326 and the intraday payables prediction engine 328 to produce an intraday receivables prediction 330 and an intraday payables prediction 332. The intraday receivables prediction 330 and the intraday payables prediction 332 may be produced on a customer and account basis. The hierarchical liquidity estimation 338 may reconcile the intraday receivables prediction 330 and the intraday payables prediction 332 in a hierarchical format to produce the estimation of intraday cash flow 340.

At block 410, the intraday cash flow optimization tool 202 monitors the estimation of intraday cash flow 340 relative to intraday operations optimization conditions 348. The intraday operations optimization conditions 348 can include one or more of: known issues 350 for account management, mitigation rules 352 of accounts, and regulations 354 for maintaining liquidity. Monitoring can be performed by the real-time alert engine 342. The monitoring can also be performed by the reinvestment engine 344 relative to the reinvestment conditions 358.

At block 412, the intraday cash flow optimization tool 202 generates an alert 356 based on determining that at least one of the intraday operations optimization conditions 348 is met. The intraday cash flow optimization tool 202 may also output one or more reinvestment options 366 based on determining that at least one of the reinvestment conditions 358 is met by the estimation of intraday cash flow 340.

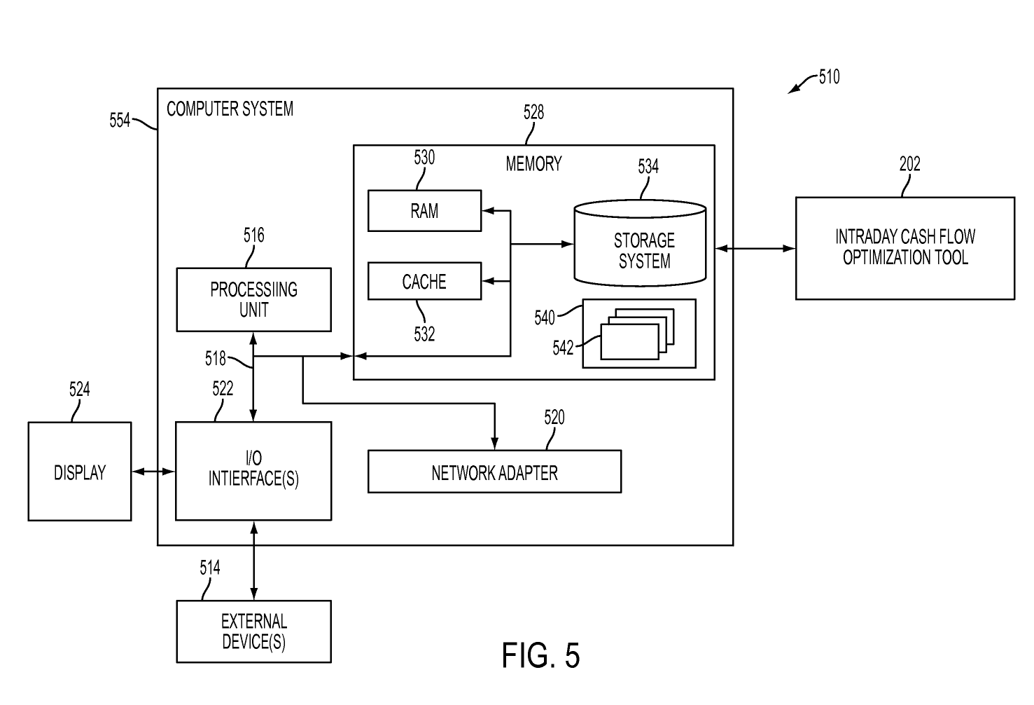

Referring now to FIG. 5, a schematic of an example of a computer system 554 in an environment 510 is shown. The computer system 554 is only one example of a suitable computer system and is not intended to suggest any limitation as to the scope of use or functionality of embodiments described herein. Regardless, computer system 554 is capable of being implemented and/or performing any of the functionality set forth hereinabove. The computer system 554 is an embodiment of the intraday cash flow optimization computer system 120 of FIG. 1.

In the environment 510, the computer system 554 is operational with numerous other general purpose or special purpose computing systems or configurations. Examples of well-known computing systems, environments, and/or configurations that may be suitable as embodiments of the computer system 554 include, but are not limited to, personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 554 may be described in the general context of computer system-executable instructions, such as program modules, being executed by one or more processors of the computer system 554. Generally, program modules may include routines, programs, objects, components, logic, data structures, and so on that perform particular tasks or implement particular abstract data types. Computer system 554 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 5, computer system 554 is shown in the form of a general-purpose computing device. The components of computer system 554 may include, but are not limited to, one or more computer processing circuits (e.g., processors) or processing units 516, a system memory 528, and a bus 518 that couples various system components including system memory 528 to processor 516. When embodied as the intraday cash flow optimization computer system 120 of FIG. 1, the processor 516 is communicatively coupled to the business-to-business integration network 118 and the financial service system 208 of FIG. 2.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 554 typically includes a variety of computer system readable media. Such media may be any available media that is accessible by computer system 554, and it includes both volatile and non-volatile media, removable and non-removable media.

System memory 528 can include computer system readable media in the form of volatile memory, such as random access memory (RAM) 530 and/or cache memory 532. Computer system 554 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. An example application program or module is depicted in FIG. 5 as intraday cash flow optimization tool 202 of FIG. 2. Although the intraday cash flow optimization tool 202 is depicted separately, it can be incorporated in any application or module. The intraday cash flow optimization tool 202 can be stored directly in the memory 528 or can be accessible by the processor 516 from a location external to the computer system 554.

Computer system 554 may also communicate with one or more external devices 514 such as a keyboard, a pointing device, a display device 524, etc.; one or more devices that enable a user to interact with computer system 554; and/or any devices (e.g., network card, modem, etc.) that enable computer system 554 to communicate with one or more other computing devices. Such communication can occur via input/output (I/O) interfaces 522. Still yet, computer system 554 can communicate with one or more networks such as a local area network (LAN), a general wide area network (WAN), and/or a public network (e.g., the Internet) via network adapter 520. As depicted, network adapter 520 communicates with the other components of computer system 554 via bus 518. It should be understood that although not shown, other hardware and/or software components could be used in conjunction with computer system 554. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

Technical effects and benefits include integration of a plurality of systems or compartmentalized entities that do not otherwise directly share information. Accessing a business-to-business integration network for transactions enables linking of the transactions with payment delivery system data and data from external sources without modifying the data sources to produce integrated information from which predictive modeling can be developed and applied. Predictive models for intraday receivables and intraday payables applied to real-time data can result in generation of real-time alerts and reinvestment options.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1-7. (canceled)

8. A system for intraday cash flow optimization, comprising:
a processor communicatively coupled to a business-to-business integration network and a financial service system; and
an intraday cash flow optimization tool executable by the processor, the intraday cash flow optimization tool configured to implement a method, the method comprising:
accessing transactions on the business-to-business integration network from a plurality of sources linked with payment delivery system data from the financial service system, wherein the transactions are associated with two or more compartmentalized entities;
characterizing the transactions based on the payment delivery system data and an analysis of customer profile data;
linking the transactions associated with two or more compartmentalized entities as integrated information based on the characterizing of the transactions;
applying an intraday receivables prediction engine and an intraday payables prediction engine to the integrated information to produce an estimation of intraday cash flow;
monitoring the estimation of intraday cash flow relative to intraday operations optimization conditions; and
generating an alert based on determining that at least one of the intraday operations optimization conditions is met.

9. The system of claim 8, wherein the analysis of the customer profile data further comprises determining customer and account information associated with the transactions on a compartmentalized entity basis.

10. The system of claim 8, wherein the intraday cash flow optimization tool is further configured to perform:
accessing external information in real-time to link with the transactions and form the integrated information, wherein the external information relates to one or more of: the transactions and the customer profile data.

11. The system of claim 8, wherein the intraday cash flow optimization tool is further configured to perform:
monitoring the estimation of intraday cash flow relative to reinvestment conditions; and
outputting one or more reinvestment options based on determining that at least one of the reinvestment conditions is met by the estimation of intraday cash flow.

12. The system of claim 8, wherein the intraday cash flow optimization tool is further configured to perform:
applying one or more offline model learning engines to produce model parameters based on identifying patterns in historical transaction data;
applying the model parameters to the transactions in real-time in combination with the customer profile data and external information from external data sources by an online transaction analytics engine comprising the intraday receivables prediction engine and the intraday payables prediction engine to produce an intraday receivables prediction and an intraday payables prediction; and
reconciling the intraday receivables prediction and the intraday payables prediction in a hierarchical format to produce the estimation of intraday cash flow.

13. The system of claim 12, wherein the intraday cash flow optimization tool is further configured to perform:
producing the intraday receivables prediction and the intraday payables prediction on a customer and account basis.

14. A computer program product for intraday cash flow optimization comprising a storage medium embodied with machine-readable program instructions, which when executed by a computer, causes the computer to implement a method, the method comprising:
accessing transactions on a business-to-business integration network from a plurality of sources linked with payment delivery system data from a financial service system, wherein the transactions are associated with two or more compartmentalized entities;
characterizing the transactions based on the payment delivery system data and an analysis of customer profile data;
linking the transactions associated with two or more compartmentalized entities as integrated information based on the characterizing of the transactions;
applying an intraday receivables prediction engine and an intraday payables prediction engine to the integrated information to produce an estimation of intraday cash flow;
monitoring the estimation of intraday cash flow relative to intraday operations optimization conditions; and
generating an alert based on determining that at least one of the intraday operations optimization conditions is met.

15. The computer program product of claim 14, wherein the analysis of the customer profile data further comprises determining customer and account information associated with the transactions on a compartmentalized entity basis.

16. The computer program product of claim 14, further comprising:
accessing external information in real-time to link with the transactions and form the integrated information, wherein the external information relates to one or more of: the transactions and the customer profile data.

17. The computer program product of claim 14, wherein the intraday operations optimization conditions comprise one or more of: known issues for account management, mitigation rules of accounts, and regulations for maintaining liquidity.

18. The computer program product of claim 14, further comprising:
monitoring the estimation of intraday cash flow relative to reinvestment conditions; and
outputting one or more reinvestment options based on determining that at least one of the reinvestment conditions is met by the estimation of intraday cash flow.

19. The computer program product of claim 14, further comprising:
applying one or more offline model learning engines to produce model parameters based on identifying patterns in historical transaction data;
applying the model parameters to the transactions in real-time in combination with the customer profile data and external information from external data sources by an online transaction analytics engine comprising the intraday receivables prediction engine and the intraday payables prediction engine to produce an intraday receivables prediction and an intraday payables prediction; and
reconciling the intraday receivables prediction and the intraday payables prediction in a hierarchical format to produce the estimation of intraday cash flow.

20. The computer program product of claim 19, further comprising:
producing the intraday receivables prediction and the intraday payables prediction on a customer and account basis.
